(19) United States
(12) Patent Application Publication
(10) Pub. No.: US 2019/0292846 A1
(43) Pub. Date: Sep. 26, 2019

(54) RETRACTABLE MATERIAL ENCLOSURE SYSTEM

(71) Applicant: Dan Conrad, Prescott, AZ (US)

(72) Inventor: Dan Conrad, Prescott, AZ (US)

(21) Appl. No.: 16/246,328

(22) Filed: Jan. 11, 2019

Related U.S. Application Data
(60) Provisional application No. 62/616,193, filed on Jan. 11, 2018.

(51) Int. Cl. E06B 9/54; E06B 9/58; E06B 9/60; E06B 9/78; E06B 9/80

(52) U.S. Cl. CPC E06B 9/54; E06B 9/581; E06B 9/60; E06B 9/78; E06B 2009/801; E06B 2009/543; E06B 2009/546; E06B 2009/587; E06B 2009/588; E06B 9/80

(57) ABSTRACT

A retractable material enclosure system that can be custom fit to provide a secondary barrier within an opening that is unobtrusive when not in use. The retractable material enclosure system may be used with different types of materials that are capable of being rolled about and retained on a cylinder or other drum type member when they are not extracted and in use. The retractable material enclosure system is particularly useful for providing a custom fit retractable screen door that fits within single or double door opening.

### CROSS-REFERENCE TO RELATED APPLICATIONS

This application claims priority to provisional patent application having Ser. No. 62/616,193, filed Jan. 11, 2018, which is herein incorporated by reference in its entirety.

### FIELD OF INVENTION

The present invention relates generally to a retractable material enclosure system that can be custom fit to provide a secondary barrier within an opening that is unobtrusive when not in use. The retractable material enclosure system may be used with different types of materials that are capable of being rolled about and retained on a cylinder or other drum type member when they are not extracted and in use. The present invention is particularly useful in providing a retractable screen capable of being custom fit within single or double door openings.

### BACKGROUND OF THE INVENTION

There are many examples of extractable and retractable screen doors and systems in the prior art which use a variety of functional features and elements. However, many such doors and systems are not easily capable of being customized to fit a variety of openings including double door openings. In addition, simple durable locking mechanisms are not often included in extractable and retractable screen assemblies especially in double door applications where it would be convenient to be able to open only one side of a dual retractable screen door assembly in order to gain access from one side of the screen to the other.

Most prior art retractable screen systems also fail to provide for easy repair of torn screens. Accordingly, there is a need for an easily customized system for providing a retractable material within a defined opening, such as a retractable screen door, that enables easy repair or the torn material, or torn screen, when tears in the material occur. There is also a need for a retractable material enclosure system, like a retractable screen door system, that includes a simple and durable locking mechanism that can be consistently utilized without having to reset or realign the retractable screen and that enables the ability to open only one side of a dual system or double door retractable screen.

### SUMMARY OF THE INVENTION

The present invention is directed to retractable material enclosure system that is capable of providing a secondary barrier within any opening having an existing framed opening that is rectangular in shape. The retractable material may include any type of material, including screen material, that can be rolled onto a cylinder, a drum, or any similarly shaped member. Both single and double openings can be enclosed with up to 60 inches wide by 120 inches high for a single opening and up to 120 inches wide by 120 inches high for a double opening.

The retractable material enclosure system includes a rollable material that is secured between a drum member and an extractor member. The drum member is internally spring loaded between an encasement spring cap (which positions the screen drum within an encasement) and a spring spline which engages the drum member internally. This combination generates the tension on the rollable material allowing it to roll onto the drum member. The extractor member, after being pulled out and away from the encasement, is secured to the opposing door frame (the door frame opposite from the frame to which the encasement is secured) with a full length vertical magnet via a receiver which also contains a full length vertical magnet. The magnets may comprise rubberized magnetic material that is separately secured to the extractor member and the receiver with T grooves and which later are joined on the side of the opening opposite the encasement to create a positive connection/latch as well as a seal for that side of the opening.

When retracted, the rollable material is collected onto the drum member which is contained within the encasement which provides protection as well as rigidity to the rolling mechanisms. The encasement has an encasement cap and an encasement spring cap which enable the alignment of the drum member within the encasement as well as the mounting of the encasement to the opening frame through the use of a screw secured through each of the encasement cap and encasement spring cap into the opening frame. The encasement cap and the encasement spring cap provide a smooth transition between the encasement and top and bottom guide members, allowing the rollable material to pass from the encasement to the guide members undamaged. The top and bottom guide members provide alignment for the extractor from the encasement to the receiver while at the same time creating a seal between the rollable material and the opening frame. The top and bottom guide members are secured through engagement with the alignment/locating tongues on the encasement caps along with securing a screw through each guide member and into the opening frame. The top and bottom guide members are fitted within the opening to fit horizontally between the encasement caps and the receiver.

The receiver may be fitted to the opening opposite of the encasement through the use of three screws secured into the opening frame. The rollable material may be attached to the drum member with double stick tape and may further be secured by the rollable material being wrapped around the drum member over itself. The other end of the rollable material may be secured in the extractor member in a similar fashion by using double stick tape and wrapping it around the extractor bar which is then inserted into the extractor member from the end of the extractor member. The extractor member also has handles which may be drilled and screwed onto the extractor member during the installation process.

The rollable material, drum member, encasement, top and bottom guide members and receiver are all custom cut to specifically fit the opening they are being mounted within. Additional components may be added to the system to complete the assembly. It will be understood by those skilled in the art that other known attachment and securing means may be used for attaching and/or securing various components of the system of the present invention to one another and/or for securing various components of the system of the present invention to one or more frame members which frame the opening for which the retractable and rollable material will cover.

In one exemplary embodiment, the retractable material enclosure system of the present invention includes an encasement, a drum member contained within the encasement for retaining a retractable and rollable material, a retractor/tensioning spring contained within the drum member, a spring spline having one end in an interference fit with the retractor/tensioning spring and another end in a clearance spline fit within an inside of the drum member, an encasement spring cap in an interference fit with an end of the encasement for retaining the drum member within the encasement, an extractor member having a magnet cavity, a material/extractor bar cavity, and an opening in communication with the material/extractor bar cavity, a material/extractor bar contained within the material/extractor bar cavity of the extractor member, a first magnet contained within the magnet cavity of the extractor member, a material having a first end connected to the drum member and a second opposite end connected to the material/extractor bar such that the material passes through the opening in the extractor member and is capable of being rolled about the drum member, a receiver member having a magnet cavity, and a second receiver magnet contained within the magnet cavity of the receiver member. The system may also include an encasement cap in an interference fit with an end of the encasement member that is opposite the end of the encasement member that has an interference fit with the encasement spring cap thus providing both ends of the encasement member with caps.

The retractable material enclosure system of the present invention may also include a top guide member and a bottom guide member for guiding the extractor member from the encasement to the receiver member. The encasement cap and the encasement spring cap may each include a locating tongue and the top and bottom guide members may each include an elongated groove along their entire length such that the locating tongues of the encasement cap and the encasement spring cap can fit into an end of the elongated groove of the top guide member and bottom guide member, respectively, to align the encasement with the top and bottom guide members and to enable the extractor member to glide along a top of the elongated grooves contained within the top and bottom guide members. A top of the receiver member is in alignment with the top guide member and a bottom of the receiver member is in alignment with the bottom guide member so that the first magnet contained within the extractor member and the second receiver magnet contained within the receiver member adhere to one another when the extractor member is pulled through the top and bottom guide members to meet the receiver member.

The retractable material enclosure system may also include at least one handle connected to the extractor member and the handle member may include a handle tab which prevents the extractor member from touching the drum member when the material is retracted onto the drum member. In one exemplification of the invention, the system may include two handles with each handle connected to an opposite side of the extractor member.

The system of the present invention may further include a first extractor plug in an interference fit with an end of the extractor member and a second extractor plug in an interference fit with an opposite end of the extractor member. A first bushing may be located between the drum member and the encasement spring cap and fixed within an end of the drum member with a clearance fit spline and a second bushing may be located between the drum member and the encasement cap and fixed within an opposite end of the drum member with a clearance fit spline. In addition, the encasement may include a smooth opening for guiding the material back onto the drum member when the material is retracted, a mounting clip cavity, and a sealing strip cavity and the retractable material enclosure system further include at least one mounting clip having a snap fit member, a locating tab, and an opening for mounting the mounting clip to a structure wherein the snap fit member of the mounting clip snap fits within the mounting clip cavity of the encasement.

In another exemplary embodiment, the retractable material enclosure system of the present invention comprises a double door retractable material enclosure system which includes (a) a first encasement; (b) a first drum member contained within the first encasement for retaining a first retractable material; (c) a first retractor spring contained within the first drum member; (d) a first spring spline having one end in an interference fit with the first retractor spring and another end in a clearance spline fit within an inside of the first drum member; (e) a first encasement spring cap in an interference fit with an end of the first encasement and a first encasement cap in an interference fit with an opposite end of the first encasement for retaining the first drum member within the first encasement; (f) a first extractor member having a magnet cavity, a material bar cavity, and an opening in communication with the material bar cavity; (g) a first material bar contained within the material bar cavity of the first extractor member; (h) a first magnet contained within the magnet cavity of the first extractor member; (i) a first material having a first end connected to the first drum member and a second opposite end connected to the first material bar such that the first material passes through the opening in the first extractor member and is capable of being rolled about the first drum member; (j) a second encasement; (k) a second drum member contained within the second encasement for retaining a second retractable material; (l) a second retractor spring contained within the second drum member; (m) a second spring spline having one end in an interference fit with the second retractor spring and another end in a clearance spline fit within an inside of the second drum member; (n) a second encasement spring cap in an interference fit with an end of the second encasement and a second encasement cap in an interference fit with an opposite end of the second encasement for retaining the second drum member within the second encasement; (o) a second extractor member having a magnet cavity, a material bar cavity, and an opening in communication with the material bar cavity; (p) a second material bar contained within the material bar cavity of the second extractor member; (q) a second magnet contained within the magnet cavity of the second extractor member; (r) a second material having a first end connected to the second drum member and a second opposite end connected to the second material bar such that the second material passes through the opening in the second extractor member and is capable of being rolled about the second drum member; (s) a first top guide member in horizontal alignment with a second top guide member wherein the first and second top guide members are connected by a top receiver so that the first extractor member can be guided from the first encasement to the top receiver and the second extractor member can be guided from the second encasement to the top receiver so that the first and second magnets can adhere to one another; and (t) a first bottom guide member in horizontal alignment with a second bottom guide member wherein the first and second bottom guide members are connected by a bottom receiver so that the first extractor member can be guided from the first encasement to the bottom receiver and the second extractor member can be guided from the second encasement to the bottom receiver so that the first and second magnets can adhere to one another.

The double door retractable material enclosure system may further include a locking system where the top and bottom receivers are top and bottom lock pin receivers each having first and second openings for receiving lock pins and the first and second extractors each have a main lock cavity where the locking system further includes a first lock cam having a center square shaped female opening and two round openings on opposite sides of the square shaped opening; a first lock knob having a square shaped male clip that corresponds to the square shaped female opening in the first lock cam where both the first lock cam and the first lock knob are both contained within the main lock cavity of the first extractor; a first lock spring housed within the first lock knob which engages the first locked knob and the first extractor; and an opposing pair of lock pins having bent ends that fit into the two round openings in the first lock cam and opposing straight ends that fit into the first openings in the top and bottom lock pin receivers. The double door retractable material enclosure system may also include a first top extractor plug having a channel which contains a portion of one of the opposing pair of lock pins where the first top extractor plug is contained within a top of the main lock cavity of the first extractor and a first bottom extractor plug having a channel which contains a portion of the other one of the opposing pair of lock pins where the first bottom extractor plug is contained within a bottom of the main lock cavity of the first extractor.

The locking system of the double door retractable material enclosure system may further include a second lock cam having a center square shaped female opening and two round openings on opposite sides of the square shaped opening; a second lock knob having a square shaped male clip that corresponds to the square shaped female opening in the second lock cam where both the second lock cam and the second lock knob are both contained within the main lock cavity of the second extractor; a second lock spring housed within the second lock knob which engages the second locked knob and the second extractor; and a second opposing pair of lock pins having bent ends that fit into the two round openings in the second lock cam and opposing straight ends that fit into the second openings in the top and bottom lock pin receivers. The double door retractable material enclosure system may also include a second top extractor plug having a channel which contains a portion of one of the second opposing pair of lock pins where the second top extractor plug is contained within a top of the main lock cavity of the second extractor and a second bottom extractor plug having a channel which contains a portion of the other one of the second opposing pair of lock pins where the second bottom extractor plug is contained within a bottom of the main lock cavity of the second extractor.

The double door retractable material enclosure system may further include two handles with each of the two handles connected to an opposite side of the first extractor member and a third handle connected to the second extractor member. Each of the handles may include a handle tab to prevent their respective extractor members from touching their respective drum members.

The first and second top guide members and the first and second bottom guide members may each include an elongated groove along their entire length and the top and bottom receivers may each include opposing locating tongues where an opposing locating tongue of the top receiver fits into an end of the elongated groove of the first top guide member, the other opposing locating tongue of the top receiver member fits into an end of the elongated groove of the second top guide member, an opposing locating tongue of the bottom receiver fits into an end of the elongated groove of the first bottom guide member, and the other opposing locating tongue of the bottom receiver member fits into an end of the elongated groove of the second bottom guide member. The double door retractable material enclosure system may also include a first mounting clip having a snap fit member, a locating tab, and an opening for mounting the first mounting clip to a structure where the snap fit member of the first mounting clip snap fits within a mounting clip cavity contained within the first encasement and a second mounting clip having a snap fit member, a locating tab, and an opening for mounting the second mounting clip to a structure where the snap fit member of the second mounting clip snap fits within a mounting clip cavity contained within the second encasement.

### BRIEF DESCRIPTION OF THE DRAWINGS

The foregoing and other features of the present disclosure will become more fully apparent from the following description, taken in conjunction with the accompanying drawings. Understanding that these drawings depict only some embodiments in accordance with the disclosure and are, therefore, not to be considered limiting of its scope, the disclosure will be described with additional specificity and detail through use of the accompanying drawings.

FIG. 1 is an isometric view of the retractable material enclosure system of the present invention in a single door configuration with portions of various elements of the system shown removed in order to view the assembly of internal components of the system;

FIG. 2 is an enlarged view of a portion of the isometric view shown in FIG. 1 with the addition of a handle to an outer side of the extractor to depict how the handle is attached to the extractor;

FIG. 3 is an isometric view of the encasement spring cap;

FIG. 4 is a top view of the encasement spring cap shown in FIG. 3;

FIG. 5 is a side view of the encasement spring cap shown in FIG. 3;

FIG. 6 is an isometric view of the encasement cap;

FIG. 7 is a top view of the encasement cap shown in FIG. 6;

FIG. 8 is a side view of the encasement cap shown in FIG. 6;

FIG. 9 is an end view of the encasement cap shown in FIG. 6;

FIG. 10 is an isometric view of the spring spline;

FIG. 11 is a top view of the spring spline shown in FIG. 10;

FIG. 12 is a side view of the spring spline shown in FIG. 10;

FIG. 13 is cross-sectional view of the drum member;

FIG. 14 is an isometric view of a bushing;

FIG. 15 is a top view of the bushing shown in FIG. 14;

FIG. 16 is a bottom view of the bushing shown in FIG. 14;

FIG. 17 is a side view if the bushing shown in FIG. 14;

FIG. 18 is a cross-sectional view of the encasement;

FIG. 19 is a cross-sectional view of the extractor member;

FIG. 20 is a cross-sectional view of a handle;

FIG. 21 is an assembly view showing how the material is held in tension between material/extractor bar contained within the extractor member and the drum member contained within the encasement;

FIG. 22 is a cross-sectional view of the top guide member;

FIG. 23 is a cross-sectional view of the bottom guide member;

FIG. 24 is a cross-sectional view of the receiver member and second receiver magnet contained within the receiver member;

FIG. 25 is an isometric view of an extractor plug;

FIG. 26 is an isometric view of a mounting clip;

FIG. 27 is a top view of the mounting clip shown in FIG. 26;

FIG. 28 is a side view of the mounting clip shown in FIG. 26;

FIG. 29 is an isometric view of the retractable material enclosure system of the present invention in a double door configuration with portions of various elements of the system shown removed in order to view the assembly of internal components of the system;

FIG. 30 is an isometric view of a locking system for use with the retractable material enclosure system shown in FIG. 29;

FIG. 31 is an isometric view of the top lock pin receiver shown in FIG. 30;

FIG. 32 is a top view of the top lock pin receiver shown in FIG. 31;

FIG. 33 is a side view of the top lock pin receiver shown in FIG. 31;

FIG. 34 is an isometric view of the bottom lock pin receiver shown in FIG. 30;

FIG. 35 is a top view of the bottom lock pin receiver shown in FIG. 34;

FIG. 36 is a side view of the bottom lock pin receiver shown in FIG. 34;

FIG. 37 is an isometric view of the lock cam shown in FIG. 30;

FIG. 38 is a top view of the lock cam shown in FIG. 37;

FIG. 39 is a side view of the lock cam shown in FIG. 37;

FIG. 40 is an isometric view of the lock knob shown in FIG. 30;

FIG. 41 is a top view of the lock knob shown in FIG. 40;

FIG. 42 is a side view of the lock knob shown in FIG. 40; and

FIG. 43 is an isometric view of a lock pin shown in FIG. 30.

### DESCRIPTION OF EXEMPLARY EMBODIMENTS

The retractable material enclosure system of the present invention is designed for the purpose of providing a secondary barrier within an opening that is unobtrusive when not in use. The retractable nature of the enclosure allows a user to leave it retracted most of the time and, when retracted, the material stays out of the weather and remains clean. The retractable material enclosure system also allows a user to pass freely through the opening without having to negotiate multiple enclosure systems when only one is being required. Both single and double openings can be enclosed with the retractable material enclosure system of the present invention. Single openings up to 60 inches wide by 120 inches high and double openings up to 120 inches wide by 120 inches high can be enclosed. The retractable material enclosure system includes a rollable and retractable material secured between a drum member and an extractor member. The drum member is internally spring loaded which generates tension on the rollable and retractable material allowing it to roll onto the drum member. When retracted onto the drum member, the rollable and retractable material is collected into an encasement which provides protection as well as rigidity to the rolling mechanisms. After extracting material by pulling the extractor member away from the encasement, the extractor member is secured to a door frame opposing the door frame securing the encasement by joining a full length vertical magnet contained within the extractor member with a full length vertical receiving magnet contained within a receiver member. Top and bottom guides provide alignment for the extractor member from the encasement to the receiver member while at the same time creating a seal between the rollable and retractable material and the frame of the opening. The rollable and retractable material, the drum member, the encasement, the top and bottom guides and the receiver member are all custom cut to specifically fit the opening they are being mounted within. Additional system parts may be used to complete the assembly.

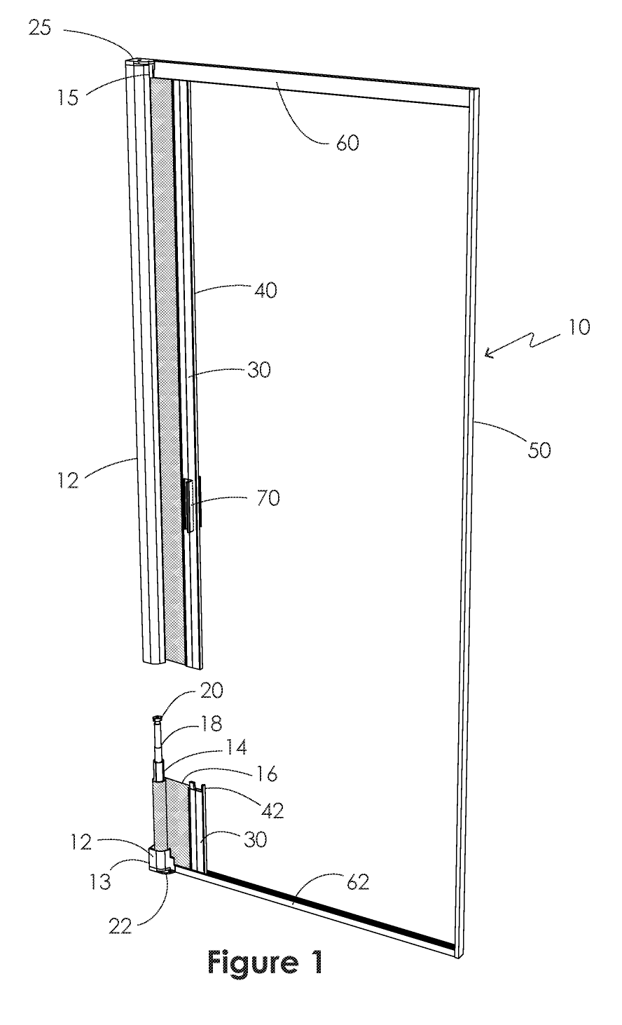

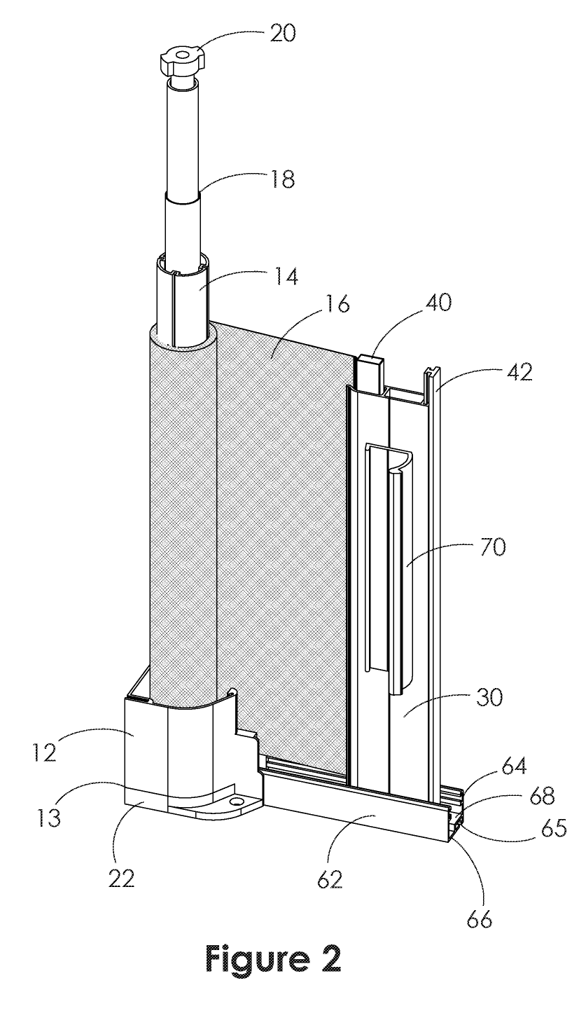

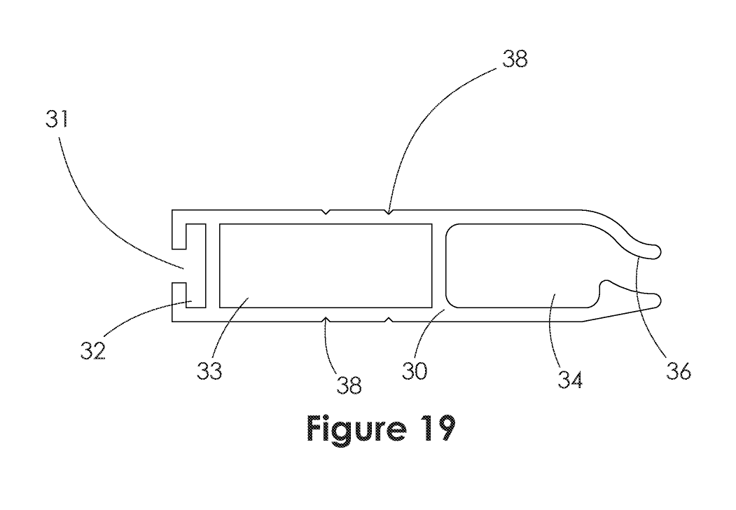

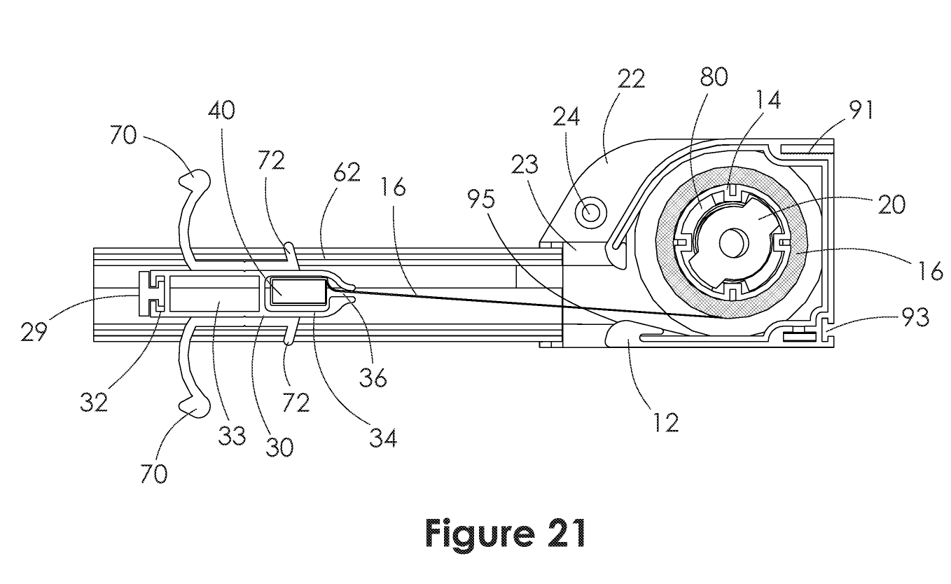

FIG. 1 is an isometric view of the retractable material enclosure system of the present invention in a single door configuration with portions of various elements of the system shown removed in order to view the assembly of internal components of the system. System 10 includes an encasement 12, a drum member 14 contained within the encasement 12 for retaining a retractable material 16, a retractor/tensioning spring 18 contained within the drum member 14, a spring spline 20 interference fit at one end with the retractor/tensioning spring 18 and clearance spline fit at an opposite end with the inside of the drum member 14, and an encasement spring cap 22 interference fit with an end 13 of the encasement 12 for retaining the drum member 14 within the encasement 12. System 10 also includes an extractor member 30 having a magnet cavity 32, a material/extractor bar cavity 34, and an opening 36 in communication with the material/extractor bar cavity 34 (See FIGS. 19 and 21), a material/extractor bar 40 contained within the material/extractor bar cavity 34 of the extractor member 30, a first magnet 42 contained within the magnet cavity 32 of the extractor member 30, a material 16 having a first end connected to the drum member 14 and a second opposite end connected to the material/extractor bar 40 so that the material 16 passes through the opening 36 in the extractor member 30 and is capable of being rolled about the drum member 14.

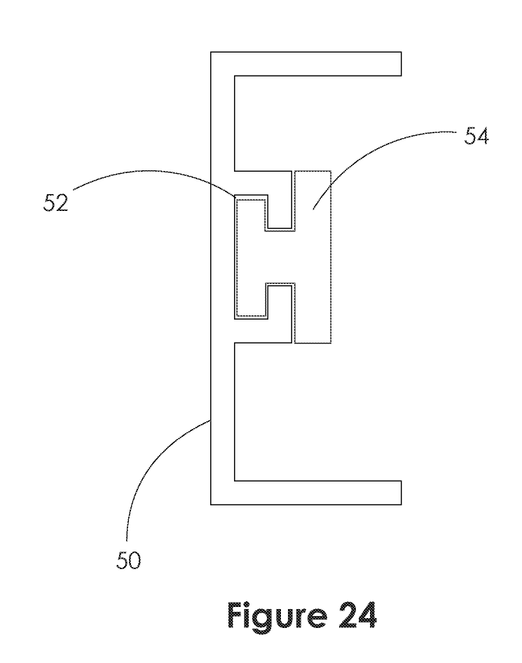

The system 10 further includes a receiver member 50 having a magnet cavity 52 and a second receiver magnet 54 contained within the magnet cavity 52 of the receiver member 50 (See FIG. 24). An encasement cap 25 interference fit with opposite end 15 of encasement 12 may also be included. System 10 may also include a top guide member 60 and a bottom guide member 62 for guiding extractor member 30 from the encasement 12 to the receiver member 50. Further, a handle 70 may be connected to extractor member 30 and in a preferred embodiment for the single door configuration, a first handle is connected to one side of the extractor member 30 and a second handle is connected to an opposite side of the extractor member.

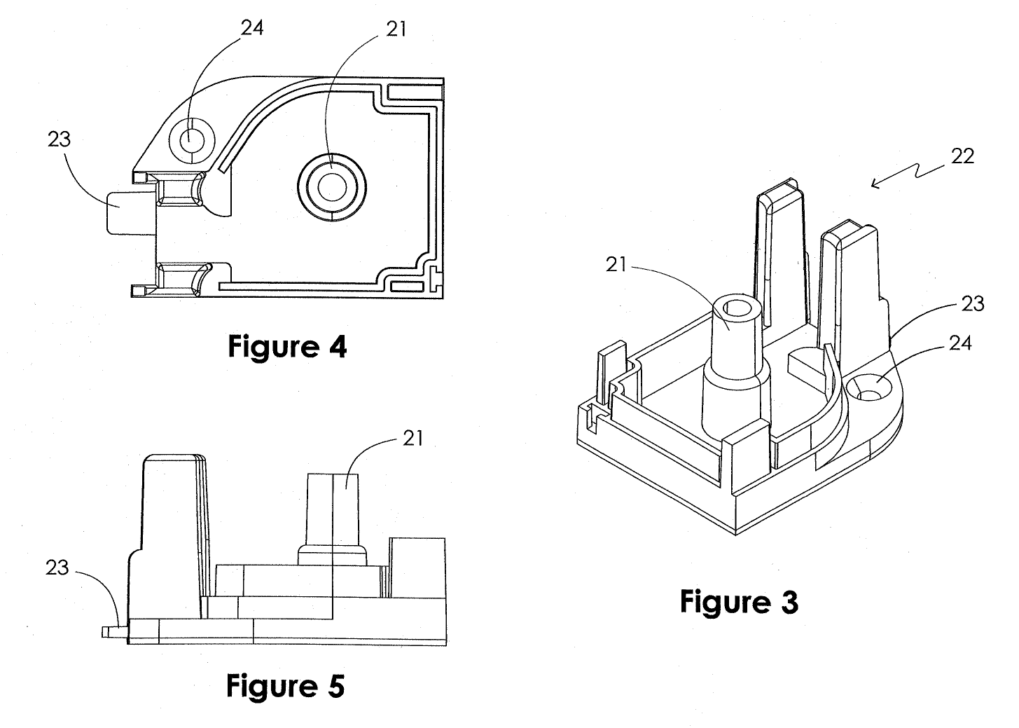

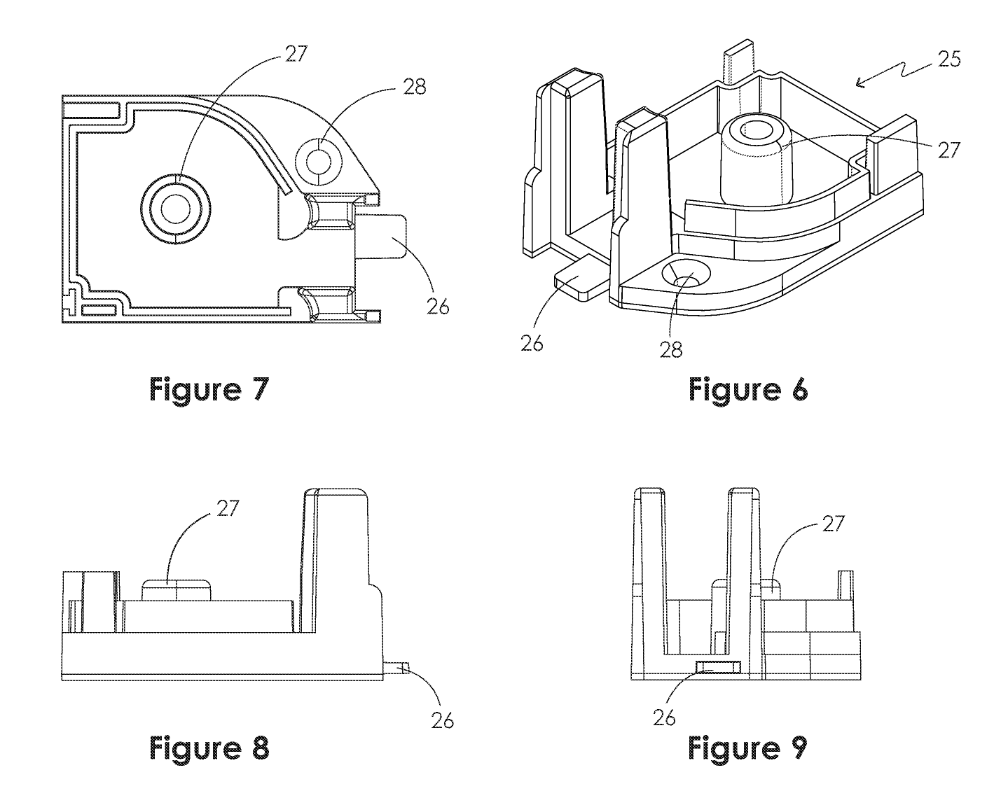

FIGS. 3-5 show various views of encasement spring cap 22. Encasement spring cap 22 is preferably an injection molded plastic component that has an interference fit with the end 13 of encasement 12. The enhancement spring cap 22 locates/positions the drum member 14 within the encasement 12 utilizing protrusion 21 and provides a locating tongue 23 for the bottom guide member 62 to align with the encasement 12. The encasement spring cap 22 also has one counter sunk hole or opening 24 for mounting the encasement spring cap 22 to a structure. The encasement spring cap 22 serves as the anchor for the retractor/tensioning spring 18. FIGS. 6-9 show various views of encasement cap 25. Encasement cap 25 is preferably an injection molded plastic component that has an interference fit with the opposite end 15 of encasement 12. The enhancement cap 25 locates/positions the drum member 14 within the encasement 12 utilizing protrusion 27 and provides a locating tongue 26 for the top guide member 62 to align with the encasement 12. The encasement cap 25 also has one counter sunk hole or opening 28 for mounting the encasement cap 25 to a structure.

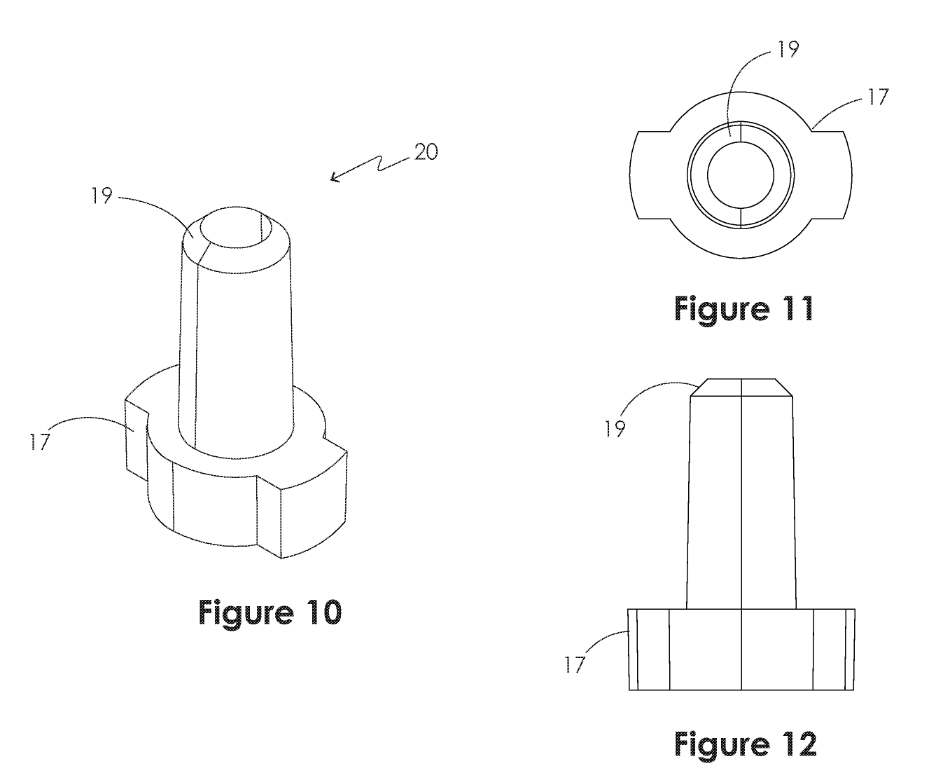

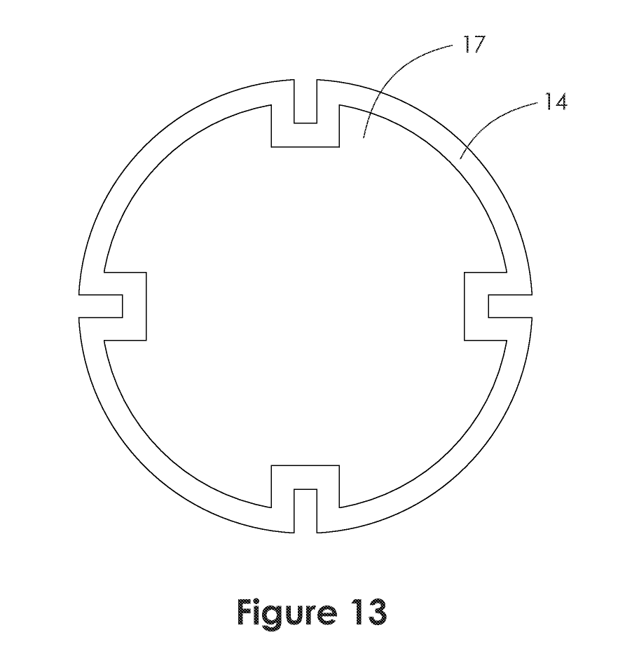

FIGS. 10-12 show various views of spring spline 20. The spring spline 20 is preferably an injection molded plastic piece with a clearance spline fit in the inside of the drum member 14 at a first end 17 of the spring spline 20 and an interference fit in the retractor/tensioning spring 18 at a second opposite end 19 of the spring spline 20. The spring spline 20 serves to lock the retractor/tensioning spring 18 into the drum member 14 and transfer the spring's torsion to the drum member 14 in order to pull the material 16 back onto the drum member 14. One spring spline 20 is needed for each door assembly. A cross-sectional view of the drum member 14 is shown in FIG. 13. The drum member 14 is preferably an extruded aluminum component that transfers the torsion from the retractor/tensioning spring 18 to the material 16 and provides a smooth surface for the material 16 to roll onto. The internal spline 11 of drum member 14 mates with the first end 17 of spring spline 20 to transfer the energy of the retractor/tensioning spring 18. Material 18 may be attached to the drum member 14 with double stick tape and then rolled over to lock it on from the pressure of the retractor/tensioning spring 18. One drum member 14 is needed for each door assembly.

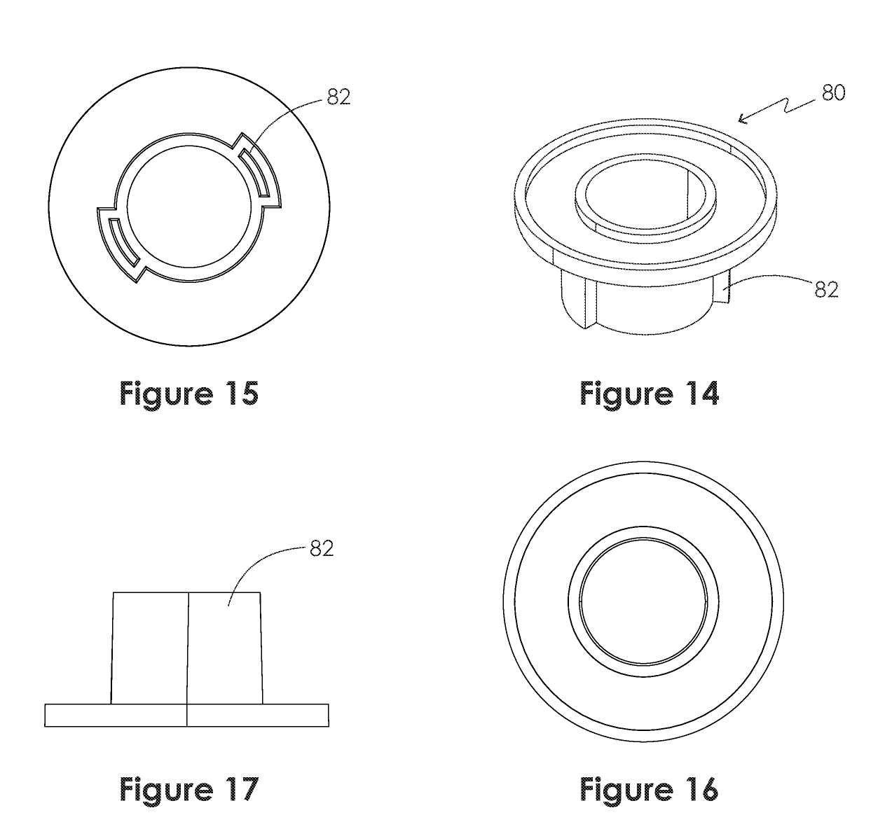

FIGS. 14-17 show various views of a bushing 80. The bushing 80 is preferably an injection molded plastic component that serves as an intermediate clearance fit piece between the drum member 14 and the encasement spring cap 22 or the encasement cap 25. The bushing 80 will be fixed in an end of the drum member 14 with a clearance fit spline 82. The bushing 80 will glide smoothly within the encasement spring cap 22 or the encasement cap 25. Two bushings 80 are needed for each door assembly. One bushing 80 is fixed within an end of drum member 14 positioned closest to the encasement spring cap 22 while another bushing 80 is positioned in an opposite end of drum member 14 positioned closest to encasement cap 25.

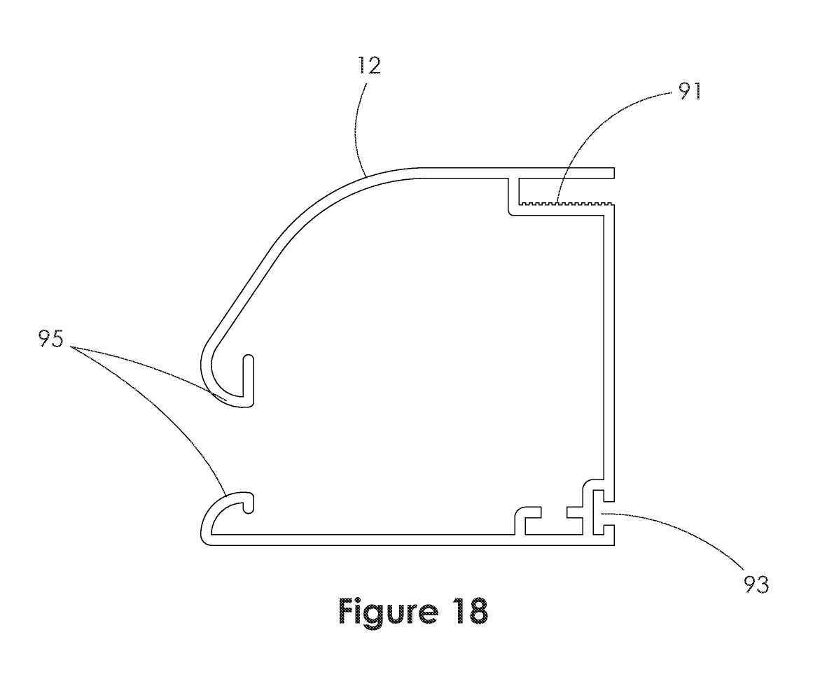

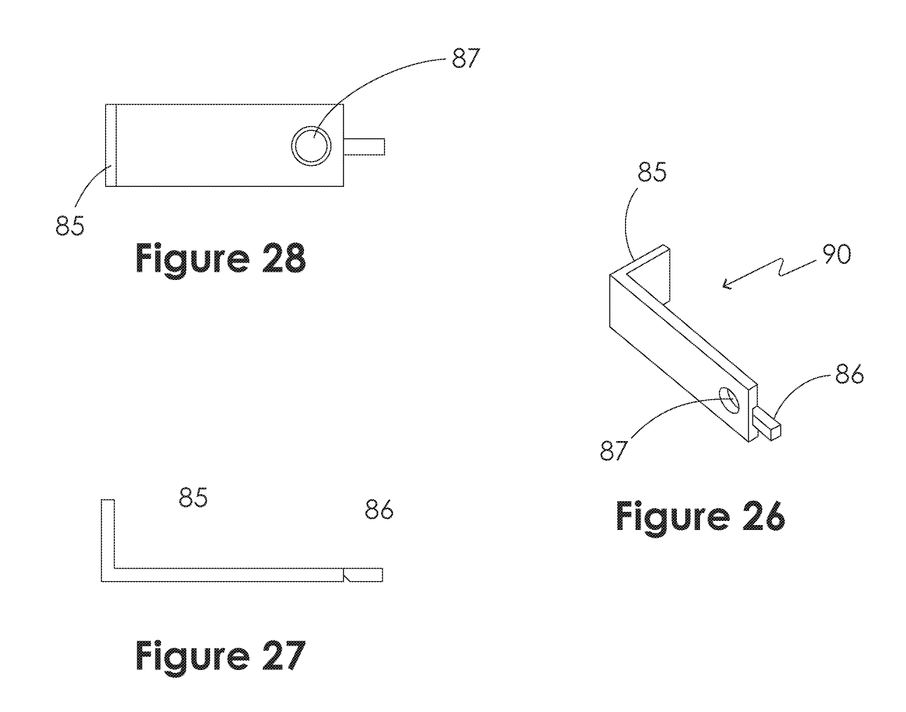

A cross-sectional view of the encasement 12 is shown in FIG. 18. The encasement 12 is preferably an extruded aluminum component that serves multiple functions. Primarily, the encasement 12 keeps the material 16 clean and out of the weather when not in use. Encasement spring cap 22 and encasement cap 25 fit into the ends 13, 15 of encasement 12 with an interference fit and align the drum member 14 in the center of encasement 12. Encasement 12 includes a mounting clip cavity 91 which provides a snap connection to mounting clips 90 (See FIGS. 26-28). Encasement 12 also includes a sealing strip cavity 93 which provides for the insertion of a sealing strip and a smooth opening 95 which provides a safe guide for directing the material 16 back onto the drum member 14. One encasement is needed for each door assembly.

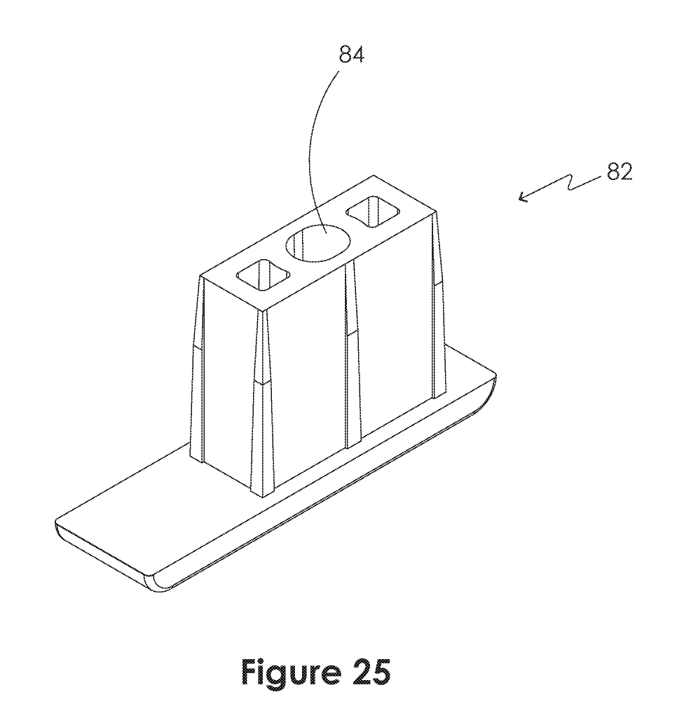

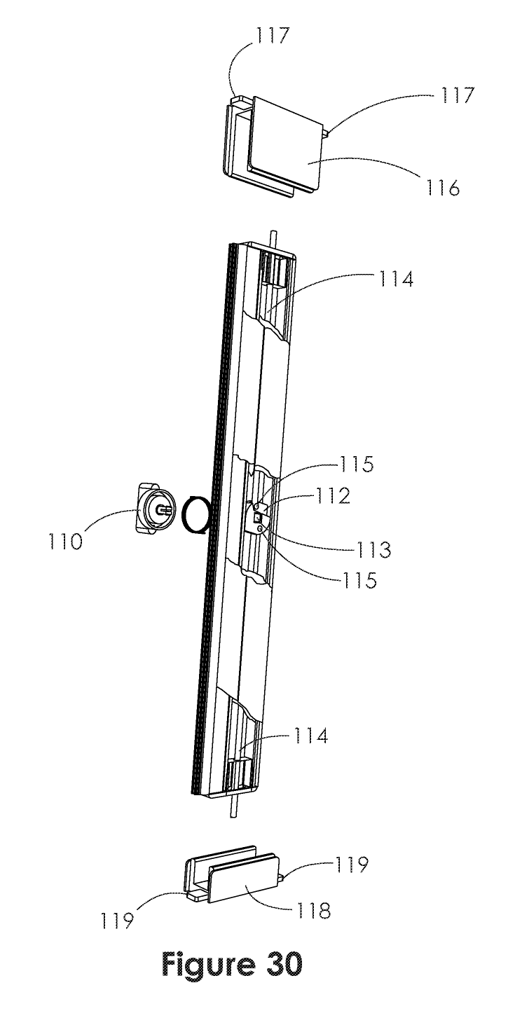

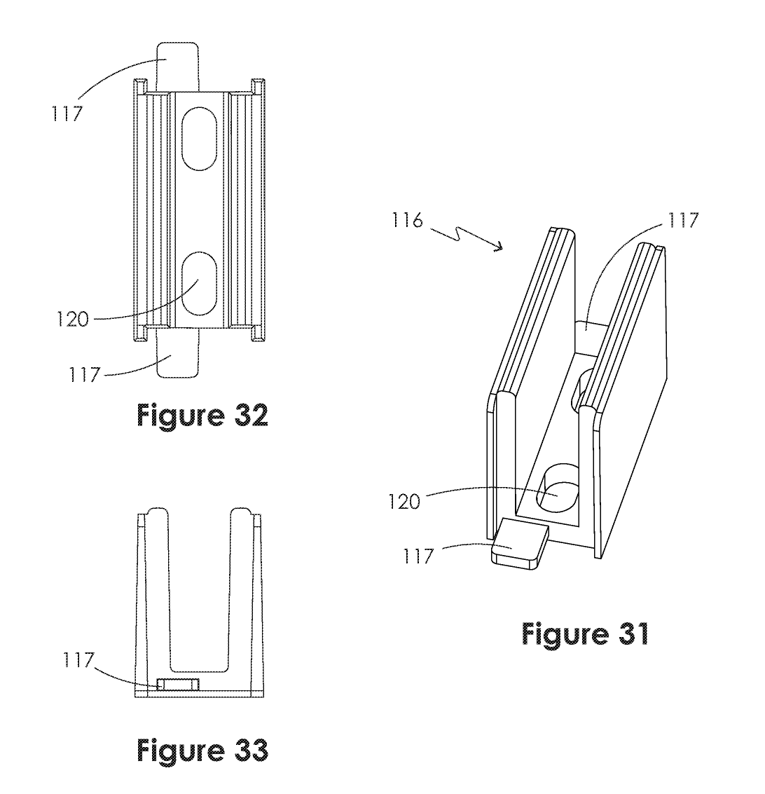

FIG. 19 is a cross-sectional view of the extractor member 30. The extractor member 30 is preferably an extruded aluminum component with five critical functions. Extractor member 30 includes a material/extractor bar cavity 34, a main lock cavity 33, and a magnet cavity 32. The unique shape of the material/extractor bar cavity 34 holds the material/extractor bar 40 from turning while at the same time providing for a smooth exit for the material 16 and lateral pressure of material 16 on the cavity opening 36 in communication with the material/extractor bar cavity 34. The main lock cavity 33 houses a lock cam and lock pins while keeping the lock pins secured in cam pin holes (See FIGS. 30-43). The magnet cavity 32 includes a slot 31 for a full vertical length magnet to be secures to the extractor member 30. Grooves 38 on the outside of the extractor member 30 act as guides while drilling holes during the installation process. The main lock cavity also serves as the interference opening for extractor plugs (See FIG. 25). There is one extractor member 30 needed for each door assembly.

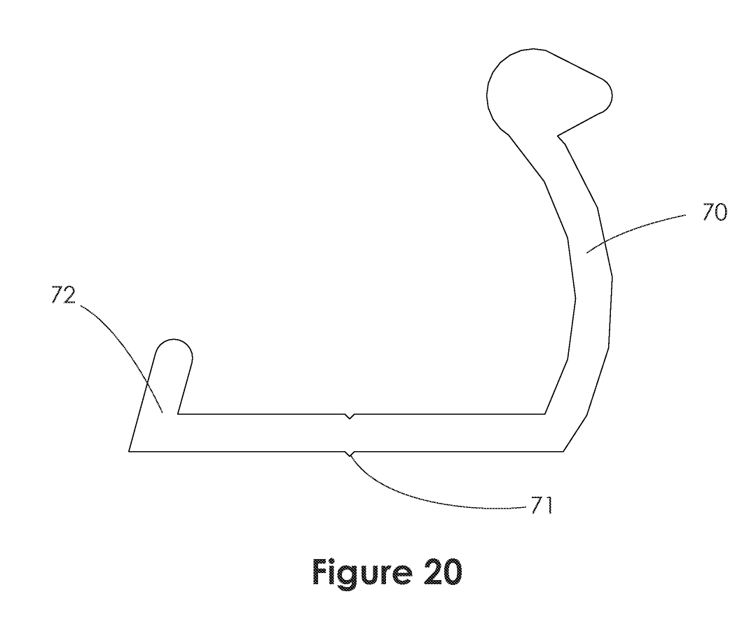

FIG. 20 is a cross-sectional view of a handle 70. The handle 70 is preferably an extruded aluminum component that is pre-drilled to mount the handle 70 to the extractor member 30 during the installation process. A corresponding tongue on the handle 70 and groove 38 on the extractor member 30 allow for consistent alignment when mounting the handle 70 to the extractor member 30. Handle tabs 72 will stop extractor member 30 from hitting the drum member 14 when material 16 is in the process of retracting onto the drum member 14. Handle tabs 72 also provide a surface to attach a dampening material for noise reduction. Two handles 70 are required for each single door assembly with each of the two handles connected to an opposite side of the extractor member 30. Three handles are required for double door assembly with two handles connected to opposite sides of a first extractor member for one door and one handle member connected to a second extractor member for the second door.

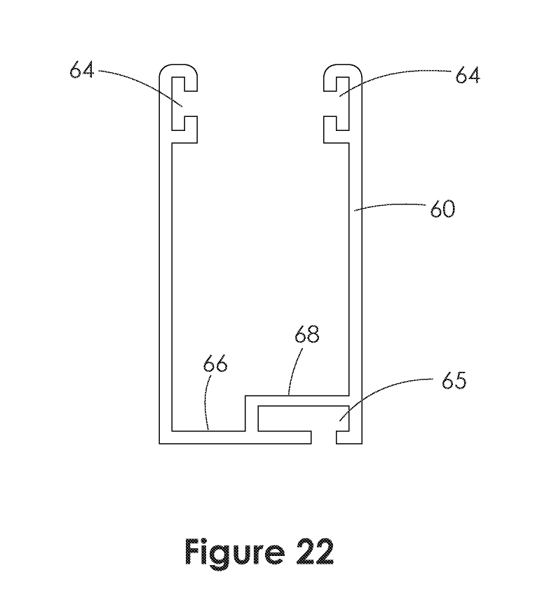

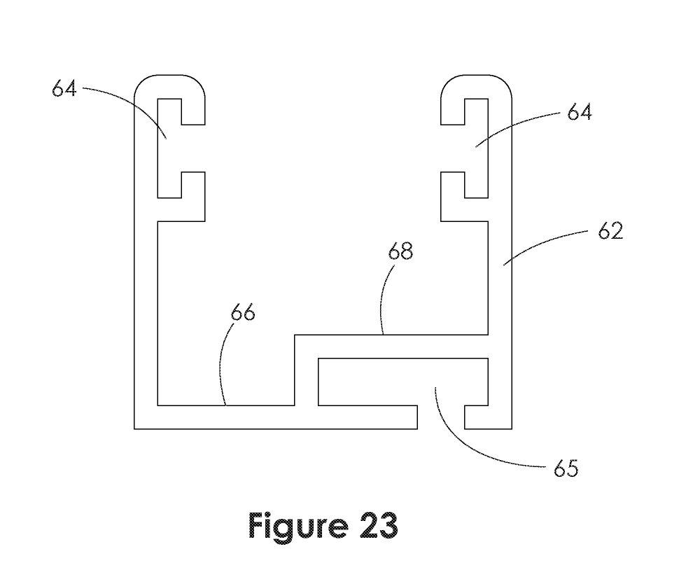

FIG. 21 is an assembly view showing how the material 16 is held in tension between material/extractor bar 40 contained within the extractor member 30 and the drum member 14 contained within the encasement 12. A cross-sectional view of a top guide member 60 is shown in FIG. 22 and a cross-sectional view of a bottom guide member 62 is shown in FIG. 23. The top and bottom guide members 60, 62 are preferably extruded aluminum components that are mounted to an existing door frame and serve to guide the extractor member 30 from the encasement 12 to the receiver member 50. The top guide member 60 is deeper since it does not interfere with the threshold of the door and it also provides more protection from screen blow out. Opposing sealing strip cavities 64 are located along opposite lengths of each of the top and bottom guide members 60, 62 so that sealing strips can be inserted in them to serve as an insect barrier against the material 16. The top and bottom guide members 60, 62 each include an elongated groove 65 along their entire length and the locating tongues 23, 26 of encasement spring cap 22 and encasement cap 25 can fit into an end of the elongated groove of the top guide member 60 and bottom guide member 62, respectively, to align the encasement 12 with the top and bottom guide members 60, 62 and to enable the extractor member 30 to glide along a top of the elongated grooves 65. In each of the guide members 60, 62, mounting holes are drilled during installation into a lower step 66 of the extrusion lying adjacent to the elongated groove 65 thereby allowing the extractor member 30 to glide smoothly on an upper step 68 which correlates to the top of the groove member 65. One top guide member 60 and one bottom guide member 62 may be required for each door assembly.

FIG. 24 is a cross-sectional view of the receiver member 50 and second receiver magnet 54 contained within the receiver member 50. The receiver member 50 is preferably an extruded aluminum component that will mount to an existing door frame and align with the top and bottom guide members 60, 62 so that the extractor member 30 can meet up with the second receiver magnet 54. The receiver magnet cavity 52 will hold the magnet 54 securely thereby allowing the extractor member 30 to be held in the extracted position. One receiver member is required for each single door assembly.

FIG. 25 is an isometric view of an extractor plug 82. The extractor plug 82 is preferably an injection molded plastic component that has an interference fit with the end of the extractor member 30 and two extractor plugs 82 will be needed per door. One extractor plug 82 will be inserted in the top of the extractor member 30 and one extractor plug 82 will be inserted in the bottom of the extractor member 30. In the double door configuration, the extractor plugs will function as the lock pin guides for the locking fixed door (See FIG. 30) and will each have a channel. FIGS. 26-28 show various views of a mounting clip 90. The mounting clip 90 is preferably an injection molded plastic component with a clearance snap fit with the encasement 12. The mounting clip 90 includes a snap fit member 85, a locating tab 86, and an opening 87 for mounting the mounting clip 90 to a structure such as an existing door frame. The mounting clip 90 can be mounted with one counter sunk screw and it stabilizes the encasement 12 during installation as well as while the door is retracting while in use. The locating tab 86 is designed to snap off during the installation process so that the sealing strip on the encasement 12 can make consistent contact with the existing door frame.

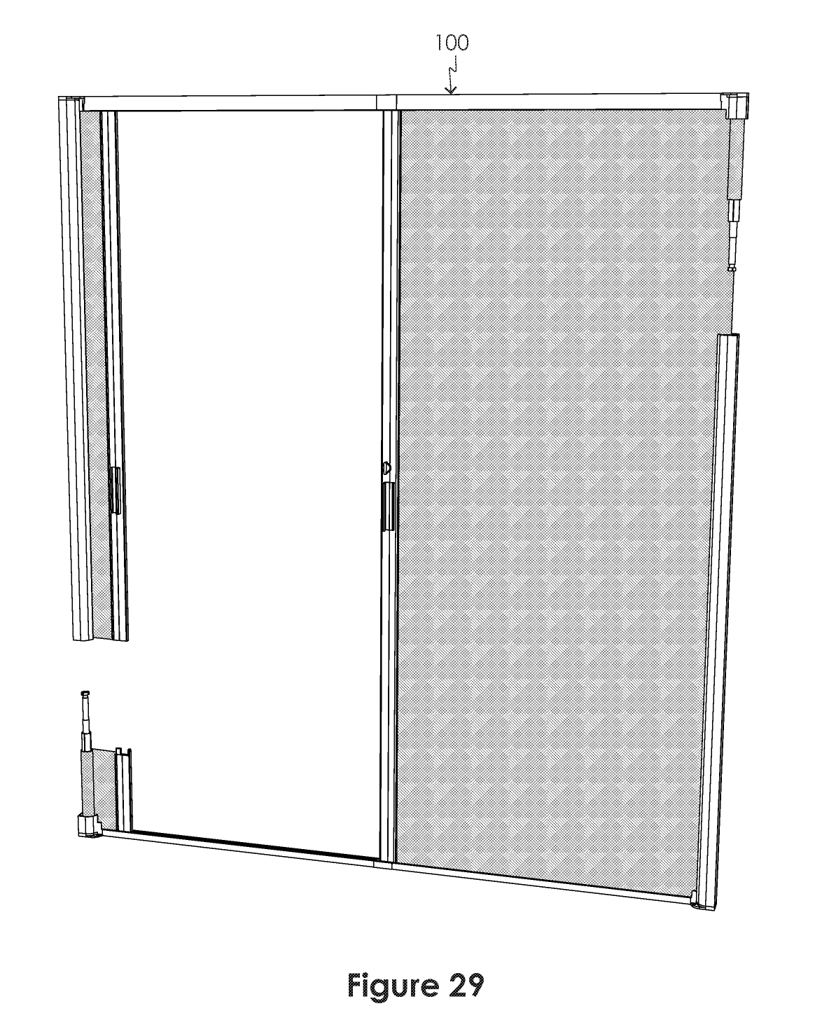

FIG. 29 is an isometric view of the retractable material enclosure system 100 of the present invention in a double door configuration with portions of various elements of the system shown removed in order to view the assembly of internal components of the system. FIG. 30 is an isometric view of a locking system for use with the retractable material enclosure system shown in FIG. 29. The present invention includes a locking system for double door application at the handle with simultaneous retractable locking pins which prevent one lock being released independently of the other. Independently releasing the locks can result in the extractor member 30 being pulled diagonally and coming out of the guide members 60, 62. This unique locking system is utilized on double doors so that only one side needs to be opened to pass through. The locking mechanism itself consists of a spring-loaded lock knob 110 connected to an internal lock cam 112 located in the extractor member 30. The lock cam 112 simultaneously actuates locking pins 114 that engage lock pin receivers 116, 118 installed in the upper and lower guide members 60, 62, respectively, and that pass through the extractor plugs 82 which serve as pin guides. A lock spring applies constant pressure on the locking pins 114 so that they automatically engage when the extractor member 30 is pulled out to the lock pin receivers 116, 118.

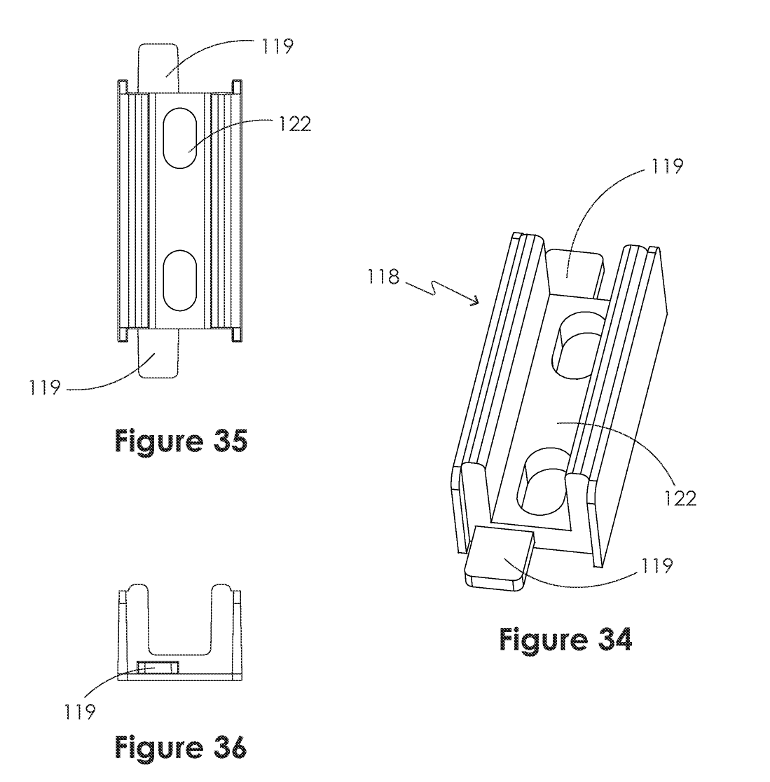

FIGS. 3-5 show various views of top lock pin receiver 116 and FIGS. 34-36 show various views of bottom lock pin receiver 118. The top lock pin receiver 116 is preferably an injection molded plastic component that has a clearance fit with the top guide member 60 in a double door configuration. This component is directional in that it has an outside and an inside face. The top lock pin receiver 116 includes opposite locating tongues 117 for engaging two separate top guide member sections (one for each of the two doors in the double door configuration) for ease of installation and a hole or opening 120 for the lock pins 114 to snap into. The bottom lock pin receiver 118 is preferably an injection molded plastic component that has a clearance fit with the top guide member 60 in a double door configuration. This component is directional in that it has an outside and an inside face. The bottom lock pin receiver 118 includes opposite locating tongues 119 for engaging two separate bottom guide member sections (one for each of the two doors in the double door configuration) for ease of installation and a hole or opening 122 for the lock pins 114 to snap into.

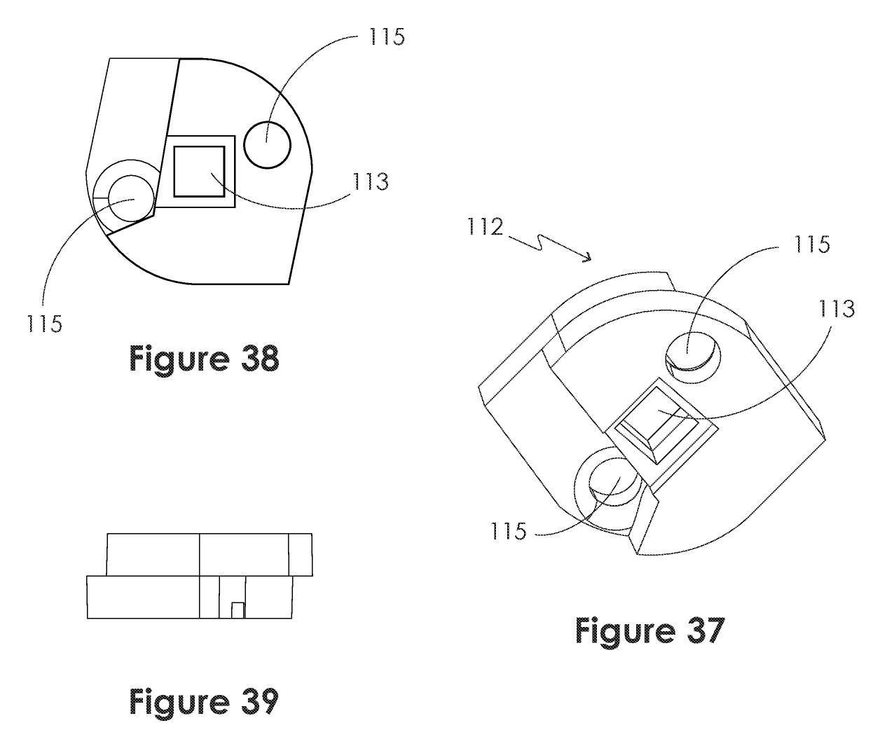

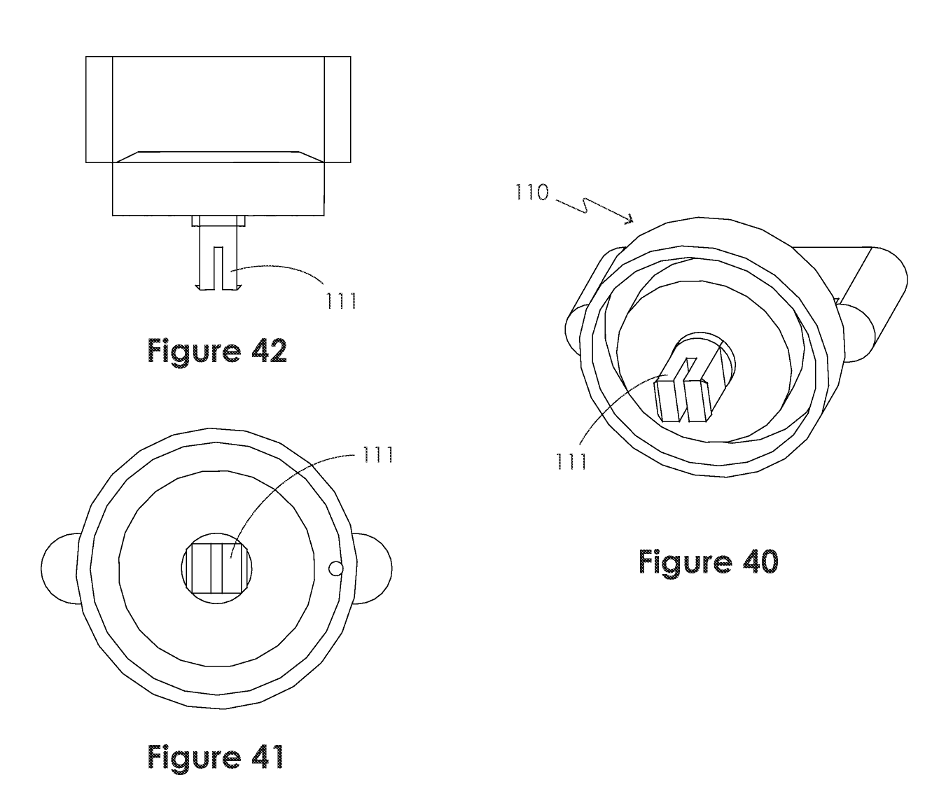

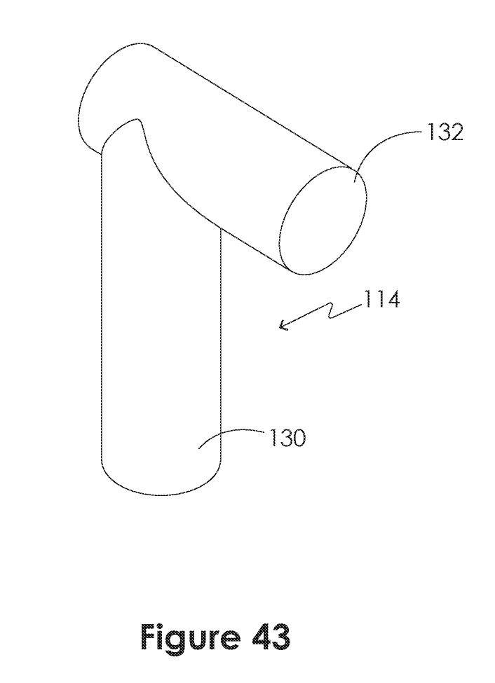

FIGS. 37-39 show various views of lock cam 112 and FIGS. 40-42 show various views of the lock knob 110. The lock cam 112 and lock knob 110 are preferably injection molded plastic components that have a loose fit in the main cavity of the extractor member 30. The lock cam component 112 has a square female opening 113 that corresponds to the square male clip 111 of the lock knob 110. The lock can 112 also includes two round openings on opposite sides of the square female opening 113 When combined with the lock spring, the lock knob 110 and the lock cam 112 serve to force the lock pins 114 into the lock pin receivers 116, 118 when pulled past them. The lock knob 110 serves to pull in the lock pins 114 in order to retract the fixed side of a double door configuration. FIG. 43 is an isometric view of a lock pin 114 shown in FIG. 30. The lock pins 114 are preferably aluminum rods that will be bent at the ends to fit into the round openings 115 in the lock cam 112. The lock pins 114 will pass through the extractor plug 82 in a double door configuration and be trimmed to proper length as part of the installation process. Two lock pins will be required for a double door configuration.

While only one locking system as shown in FIG. 30 may be needed for a double door configuration, it is possible to include two separate locking systems, one locking system within each extractor member of separate retractable doors thereby enabling either extended door to lock in place so that either retractable door can be opened. It is also possible to include the locking system shown in FIG. 30 within an extractor member of a single retractable configuration with top and bottom lock pin receives being secured within a top and bottom of the receiver member so that the single retractable door is automatically locked when in its extracted position.

The screen attachment method at the extractor member 30 enables reattachment of a torn material (e.g. a torn screen) without requiring a factory process. Typically, when a screen is damaged, it tears where the screen attaches to the extractor member. With the system of the present invention, it is possible to repair a torn screen without replacing the entire screen and without requiring a factory attachment method. This provides for a much more sustainable product. The system includes a custom extruded extractor member 30 that holds the internal material/extractor bar 40 securely allowing for even tension between the material/extractor bar 40 and the drum member 14. The material or screen 16 is attached to the material/extractor bar 40 using double sided tape and is then wrapped over the material/extractor bar 40 and slid into the material/extractor bar cavity within the extractor member 30. The pressure of the wrapping confined within the extractor member 40 combined with the tension created by the retractor/tensioning spring 18 serve to lock the material or screen evenly within the extractor member 30 until such time that the material or screen needs to be repaired. At that time, the material/extractor bar 40 can be removed from the extractor member 30 and the material or screen can be trimmed and reattached without costly replacement parts.

The drawings and description of exemplary embodiments of the invention herein shows various exemplary embodiments of the invention. These exemplary embodiments and modes are described in sufficient detail to enable those skilled in the art to practice the invention and are not intended to limit the scope, applicability, or configuration of the invention in any way. Rather, the following disclosure is intended to teach both the implementation of the exemplary embodiments and modes and any equivalent modes or embodiments that are known or obvious to those reasonably skilled in the art. Additionally, all included examples are non-limiting illustrations of the exemplary embodiments and modes, which similarly avail themselves to any equivalent modes or embodiments that are known or obvious to those reasonably skilled in the art.

Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters, or other operating requirements without departing from the scope of the instant invention and are intended to be included in this disclosure.

Unless specifically noted, it is the Applicant's intent that the words and phrases in the specification and the claims be given the commonly accepted generic meaning or an ordinary and accustomed meaning used by those of ordinary skill in the applicable arts. In the instance where these meanings differ, the words and phrases in the specification and the claims should be given the broadest possible, generic meaning. If any other special meaning is intended for any word or phrase, the specification will clearly state and define the special meaning.

1. A retractable material enclosure system comprising:
an encasement a drum member contained within the encasement for retaining a retractable material;
a retractor spring contained within the drum member;
a spring spline having one end in an interference fit with the retractor spring and another end in a clearance spline fit within an inside of the drum member;
an encasement spring cap in an interference fit with an end of the encasement for retaining the drum member within the encasement;
an extractor member having a magnet cavity, a material bar cavity, and an opening in communication with the material bar cavity;
a material bar contained within the material bar cavity of the extractor member;
a first magnet contained within the magnet cavity of the extractor member;
a material having a first end connected to the drum member and a second opposite end connected to the material bar such that the material passes through the opening in the extractor member and is capable of being rolled about the drum member;
a receiver member having a magnet cavity; and
a second receiver magnet contained within the magnet cavity of the receiver member.

2. The retractable material enclosure system of claim 1 further comprising an encasement cap in an interference fit with an opposite end of the encasement.

3. The retractable material enclosure system of claim 2 further comprising a top guide member and a bottom guide member for guiding the extractor member from the encasement to the receiver member.

4. The retractable material enclosure system of claim 3 wherein the encasement cap and the encasement spring cap each include a locating tongue and the top and bottom guide members each include an elongated groove along their entire length such that the locating tongues of the encasement cap and the encasement spring cap can fit into an end of the elongated groove of the top guide member and bottom guide member, respectively, to align the encasement with the top and bottom guide members and to enable the extractor member to glide along a top of the elongated grooves.

5. The retractable material enclosure system of claim 4 wherein a top of the receiver member is in alignment with the top guide member and a bottom of the receiver member is in alignment with the bottom guide member such that the first magnet contained within the extractor member and the second receiver magnet contained within the receiver member adhere to one another when the extractor member is pulled through the top and bottom guide members to meet the receiver member.

6. The retractable material enclosure system of claim 1 further comprising at least one handle connected to the extractor member.

7. The retractable material enclosure system of claim 6 wherein said at least one handle includes a handle tab which prevents the extractor member from touching the drum member when the material is retracted onto the drum member.

8. The retractable material enclosure system of claim 7 comprising two handles with each handle connected to an opposite side of the extractor member.

9. The retractable material enclosure system of claim 1 further comprising a first extractor plug in an interference fit with an end of the extractor member and a second extractor plug in an interference fit with an opposite end of the extractor member.

10. The retractable material enclosure system of claim 2 further comprising a first bushing located between the drum member and the encasement spring cap and fixed within an end of the drum member with a clearance fit spline and a second bushing located between the drum member and the encasement cap and fixed within an opposite end of the drum member with a clearance fit spline.

11. The retractable material enclosure system of claim 1 wherein the encasement comprises a smooth opening for guiding the material back onto the drum member when the material is retracted, a mounting clip cavity, and a sealing strip cavity and the retractable material enclosure system further comprises at least one mounting clip having a snap fit member, a locating tab, and an opening for mounting the mounting clip to a structure wherein the snap fit member of the mounting clip snap fits within the mounting clip cavity of the encasement.

12. A double door retractable material enclosure system comprising:
a first encasement;
a first drum member contained within the first encasement for retaining a first retractable material;
a first retractor spring contained within the first drum member;
a first spring spline having one end in an interference fit with the first retractor spring and another end in a clearance spline fit within an inside of the first drum member;
a first encasement spring cap in an interference fit with an end of the first encasement and a first encasement cap in an interference fit with an opposite end of the first encasement for retaining the first drum member within the first encasement;
a first extractor member having a magnet cavity, a material bar cavity, and an opening in communication with the material bar cavity;
a first material bar contained within the material bar cavity of the first extractor member;
a first magnet contained within the magnet cavity of the first extractor member;
a first material having a first end connected to the first drum member and a second opposite end connected to the first material bar such that the first material passes through the opening in the first extractor member and is capable of being rolled about the first drum member;
a second encasement;
a second drum member contained within the second encasement for retaining a second retractable material;
a second retractor spring contained within the second drum member;
a second spring spline having one end in an interference fit with the second retractor spring and another end in a clearance spline fit within an inside of the second drum member;
a second encasement spring cap in an interference fit with an end of the second encasement and a second encasement cap in an interference fit with an opposite end of the second encasement for retaining the second drum member within the second encasement;
a second extractor member having a magnet cavity, a material bar cavity, and an opening in communication with the material bar cavity;
a second material bar contained within the material bar cavity of the second extractor member;
a second magnet contained within the magnet cavity of the second extractor member;
a second material having a first end connected to the second drum member and a second opposite end connected to the second material bar such that the second material passes through the opening in the second extractor member and is capable of being rolled about the second drum member;
a first top guide member in horizontal alignment with a second top guide member wherein the first and second top guide members are connected by a top receiver so that the first extractor member can be guided from the first encasement to the top receiver and the second extractor member can be guided from the second encasement to the top receiver so that the first and second magnets can adhere to one another; and
a first bottom guide member in horizontal alignment with a second bottom guide member wherein the first and second bottom guide members are connected by a bottom receiver so that the first extractor member can be guided from the first encasement to the bottom receiver and the second extractor member can be guided from the second encasement to the bottom receiver so that the first and second magnets can adhere to one another.

13. The double door retractable material enclosure system of claim 12 further comprising a locking system wherein the top and bottom receivers are top and bottom lock pin receivers each having first and second openings therein for receiving lock pins and the first and second extractors each have a main lock cavity and wherein the locking system further comprises:
a first lock cam having a center square shaped female opening and two round openings on opposite sides of the square shaped opening;
a first lock knob having a square shaped male clip that corresponds to the square shaped female opening in the first lock cam wherein both the first lock cam and the first lock knob are both contained within the main lock cavity of the first extractor;
a first lock spring housed within the first lock knob which engages the first locked knob and the first extractor; and
an opposing pair of lock pins having bent ends that fit into the two round openings in the first lock cam and opposing straight ends that fit into the first openings in the top and bottom lock pin receivers.

14. The double door retractable material enclosure system of claim 13 wherein the locking system further comprises:
a second lock cam having a center square shaped female opening and two round openings on opposite sides of the square shaped opening;
a second lock knob having a square shaped male clip that corresponds to the square shaped female opening in the second lock cam wherein both the second lock cam and the second lock knob are both contained within the main lock cavity of the second extractor;
a second lock spring housed within the second lock knob which engages the second locked knob and the second extractor; and
a second opposing pair of lock pins having bent ends that fit into the two round openings in the second lock cam and opposing straight ends that fit into the second openings in the top and bottom lock pin receivers.

15. The double door retractable material enclosure system of claim 13 further comprising:
a first top extractor plug having a channel therein which contains a portion of one of the opposing pair of lock pins wherein the first top extractor plug is contained within a top of the main lock cavity of the first extractor; and
a first bottom extractor plug having a channel therein which contains a portion of the other one of the opposing pair of lock pins wherein the first bottom extractor plug is contained within a bottom of the main lock cavity of the first extractor.

16. The double door retractable material enclosure system of claim 14 further comprising:
a first top extractor plug having a channel therein which contains a portion of one of the opposing pair of lock pins wherein the first top extractor plug is contained within a top of the main lock cavity of the first extractor;
a first bottom extractor plug having a channel therein which contains a portion of the other one of the opposing pair of lock pins wherein the first bottom extractor plug is contained within a bottom of the main lock cavity of the first extractor;
a second top extractor plug having a channel therein which contains a portion of one of the second opposing pair of lock pins wherein the second top extractor plug is contained within a top of the main lock cavity of the second extractor; and
a second bottom extractor plug having a channel therein which contains a portion of the other one of the second opposing pair of lock pins wherein the second bottom extractor plug is contained within a bottom of the main lock cavity of the second extractor.

17. The double door retractable material enclosure system of claim 12 further comprising two handles with each of the two handles connected to an opposite side of the first extractor member and a third handle connected to the second extractor member.

18. The double door retractable material enclosure system of claim 17 wherein each handle includes a handle tab.

19. The double door retractable material enclosure system of claim 12 wherein the first and second top guide members and the first and second bottom guide members each include an elongated groove along their entire length and the top and bottom receivers each include opposing locating tongues where an opposing locating tongue of the top receiver fits into an end of the elongated groove of the first top guide member, the other opposing locating tongue of the top receiver member fits into an end of the elongated groove of the second top guide member, an opposing locating tongue of the bottom receiver fits into an end of the elongated groove of the first bottom guide member, and the other opposing locating tongue of the bottom receiver member fits into an end of the elongated groove of the second bottom guide member.

20. The double door retractable material enclosure system of claim 12 further comprising:
a first mounting clip having a snap fit member, a locating tab, and an opening for mounting the first mounting clip to a structure wherein the snap fit member of the first mounting clip snap fits within a mounting clip cavity contained within the first encasement; and
a second mounting clip having a snap fit member, a locating tab, and an opening for mounting the second mounting clip to a structure wherein the snap fit member of the second mounting clip snap fits within a mounting clip cavity contained within the second encasement.
